(19) United States
(12) Patent Application Publication
(10) Pub. No.: US 2024/0403050 A1
(43) Pub. Date: Dec. 5, 2024

(54) VECTOR COMPARISON AND/OR POPULATION COUNT OPERATIONS

(71) Applicant: Arm Limited, Cambridge (GB)

(72) Inventors: Joshua Randall, Austin, TX (US); Siying Feng, Austin, TX (US)

(21) Appl. No.: 18/509,121

(22) Filed: Nov. 14, 2023

Related U.S. Application Data
(63) Continuation-in-part of application No. 18/329,456, filed on Jun. 5, 2023.

(51) Int. Cl. G06F 9/30

(52) U.S. Cl. CPC G06F 9/30098; G06F 9/30021; G06F 9/30036; G06F 9/30145

(57) ABSTRACT

The present disclosure relates generally to integrated circuits and relates more particularly to vector comparison and/or population count operations, such as for vector sorting, merging, and/or intersection.

### BACKGROUND

### Field

The present disclosure relates generally to integrated circuits and relates more particularly to vector comparison and/or population count operations, such as for vector sorting, merging, and/or intersection.

### Information

Integrated circuit devices, such as processors, for example, may be found in a wide range of electronic device types. Computing devices, for example, may include integrated circuit devices, such as processors, to process signals and/or states representative of diverse content types for a variety of purposes. Signal and/or state processing techniques continue to evolve. For example, some integrated circuit devices may include circuitry to implement a vector architecture, including circuitry to perform vector permutation operations.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a diagram illustrating an example vector permutation operation, in accordance with an embodiment;

FIG. 2 is a diagram illustrating an example indexed vector permutation operation, in accordance with an embodiment;

FIG. 3 is a diagram illustrating a particular example indexed vector permutation operation, in accordance with an embodiment;

FIG. 4 is a schematic block diagram depicting circuitry to perform an indexed vector permutation operation, in accordance with an embodiment;

FIG. 5 is an illustration depicting an example single vector sort operation, including circuitry to perform an indexed move operation, in accordance with an embodiment;

FIG. 6 is a diagram showing an example merge-sort operation, in accordance with an embodiment;

FIG. 7 is a graph depicting example estimated performance measurements for a plurality of merge-sort implementations, in accordance with an embodiment;

FIG. 8 is an illustration showing an example specification for an indexed move operation, in accordance with an embodiment;

FIG. 9 is a flow diagram depicting an example process for performing an indexed vector permutation operation, in accordance with an embodiment;

FIG. 10 is a diagram illustrating an example vector compare operation, in accordance with an embodiment;

FIG. 11 is an illustration showing an example specification for a vector compare operation, in accordance with an embodiment;

FIG. 12 is a diagram illustrating an example row/column population count operation, in accordance with an embodiment;

FIG. 13 is an illustration showing an example specification for row/column population count operation, in accordance with an embodiment;

FIG. 14 is an illustration depicting an example single vector sort operation, including circuitry to perform an indexed move operation, in accordance with an embodiment;

FIG. 15 depicts an illustration of an example merge-sort operation, in accordance with an embodiment;

FIG. 16 is a diagram showing an example merge-sort operation, in accordance with an embodiment;

FIG. 17 depicts an illustration of an example vector intersect operation, in accordance with an embodiment;

FIG. 18 is a diagram showing an example vector intersect operation, in accordance with an embodiment;

FIG. 19 is a diagram showing an example merge-sort operation, without duplicates, in accordance with an embodiment;

FIG. 20 is a diagram showing a continuation of an example merge-sort operation, without duplicates, in accordance with an embodiment;

FIG. 21 is a flow diagram depicting an example process for performing a vector compare operation, in accordance with an embodiment;

FIG. 22 is a schematic block diagram depicting an example processing device, in accordance with an embodiment;

FIG. 23 depicts a graph showing example simulation results; and

FIG. 24 shows a simulator implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned, integrated circuit devices, such as processors, for example, may be found in a wide range of electronic device types. Computing devices, for example, may include integrated circuit devices, such as processors, to process signals and/or states representative of diverse content types for a variety of purposes. Signal and/or state processing techniques continue to evolve. For example, some integrated circuit devices may include circuitry to implement a vector architecture, including circuitry to perform vector permutation operations.

As utilized herein, “permutation” and/or the like refers to particular arrangements of data elements in an array, vector, matrix, etc. For example, [3, 2, 1] and [1, 3, 2] may comprise permutations of vector [1, 2, 3]. A “vector permutation operation” and/or the like refers to affecting particular arrangements of elements of a vector, which may include storing particular elements of one or more vectors, arrays, etc. to particular and/or specified ordered positions within a register. For example, vector permutation operations may include re-arranging a vector of data elements (e.g., values, signals, states, etc.) within a register and/or may include transferring a vector of data elements from one register to another with the data elements having a particular order of some type. In some circumstances, such re-arranging and/or transferring may include a processor and/or other circuitry writing data elements from a register to a storage (e.g., memory) and then storing the data elements to the same register and/or to a different register according to a particular and/or specified order. Vector permutation operations may find utility in any of a wide range of applications, processes, computations, instructions, etc. In some circumstances, vector permutation operations may be utilized to process matrices and/or arrays (e.g., sparse data sets) as part of a neural network implementation and/or as part of any of a wide range of other applications, for example. Of course, subject matter is not limited in scope in these respects.

In some circumstances, vector permutation operations may include memory scatter and/or memory gather operations, wherein data elements may be read from a first register, written to memory, and then stored to a second register in a particular and/or specified order, for example. One particular disadvantage to vector permutation operations including memory scatter and/or memory gather operations, for example, is the overhead involved in accessing memory to perform the scatter and/or gather operations. As explained more fully below, improved efficiency, performance, etc., may be achieved via embodiments wherein vector permutation operations and/or the like may be performed without accesses to and/or from memory.

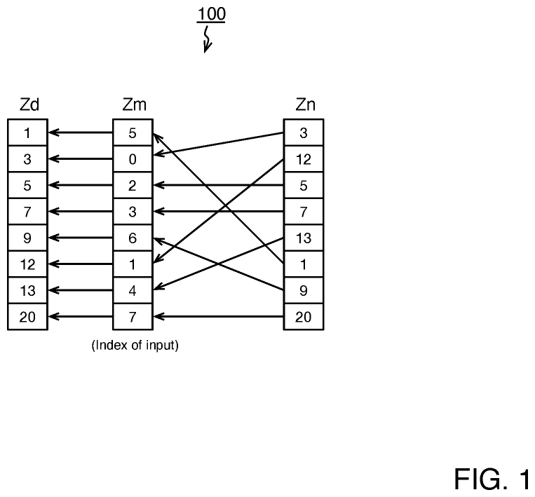

FIG. 1 is a diagram illustrating an example vector permutation operation 100. In some circumstances, a vector permutation operation such as example vector permutation operation 100 depicted in FIG. 1 may comprise a vector table (TBL) instruction and/or an extended vector table (TBX) instruction for a Scalable Vector Extension (SVE) instruction set architecture and/or for a Scalable Matrix Extension (SME) instruction set architecture from ARM Limited, for example, and/or may comprise a vector permutation (VPERM) instruction and/or the like for an x86 instruction set architecture from Intel, Corp., for example. These example instructions may include taking at least one vector of values (e.g., input vector Zn depicted in FIG. 1) stored at ordered positions of at least a first register and selecting values at particular ordered positions of the first register to write to particular ordered positions of a second register (e.g., output vector Zd). For these example instructions, an index vector (e.g., index vector Zm), stored in a third register, for example, may specify which values from particular ordered positions of the input vector are to be stored in particular ordered positions of the output vector, as demonstrated below.

For example vector permutation operation 100, input vector Zn may comprise a plurality of values stored at ordered positions of a first register. For example vector permutation operation 100, input vector Zn may comprise values [3, 12, 5, 7, 13, 1, 9, 20] ordered from a 0^{th} position to a 7^{th} position, wherein a value of “3” is stored at a 0^{th} position of vector Zn, a value of “12” is stored at a 1^{st} position of Zn, a value of “5” is stored at a 2^{nd} position of Zn, etc. For example vector permutation operation 100, the values of Zn are to be re-arranged and stored as an output vector Zd in a second register, wherein the re-arrangement is determined by the values of index vector Zm stored in a third register. For example vector permutation operation 100, individual values of index vector Zm may specify a particular position of input vector Zn for a corresponding position of output vector Zd. That is, for example, the value “5” stored at the 0^{th} position of index vector Zm indicates that the value stored at the 5^{th} position of input vector Zn is to be stored at the 0^{th} position of output vector Zd (e.g., value “1” from the 5^{th} position of input vector Zn is stored at the 0^{th} position of output vector Zd as specified by the value at the 0^{th} position of index vector Zm). Also, for example, the value “6” stored at the 4^{th} position of index vector Zm indicates that the value stored at the 6^{th} position of input vector Zn is to be stored at the 4^{th} position of output vector Zd (e.g., value “9” from 6^{th} position of input vector Zn is stored at the 4^{th} position of output vector Zd as specified by the value at the 4^{th} position of index vector Zm), and so on. Example vector permutation operation 100 may be looked at as a gather of values from one or more input vectors to generate an output vector, which may be analogous in at least some respects to a memory gather operation.

One potential drawback of example vector permutation operation 100, discussed above, is that some algorithms for some instruction set architectures may produce output-based indices that cannot use input-based permute instructions, such as the TBL, TBX and/or VPERM instructions mentioned above, for example. To address these issues, a different type of indexed vector permutation operation is proposed, as discussed more fully below.

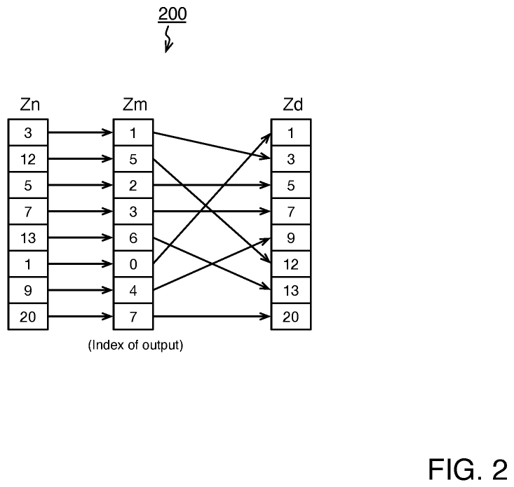

FIG. 2 is a diagram illustrating an embodiment 200 of an example indexed vector permutation operation and/or instruction (e.g., IDXMOV operation and/or instructions). In implementations, example 200 may comprise a method of indexed vector permutation operations. Although example vector permutation operation 100 and example IDXMOV operation 200 appear to have some similar characteristics, they may differ in important ways. For example, as described above, example vector permutation operation 100 may utilize an index vector Zm whose values describe positions within an input vector Zn. In contrast, example IDXMOV operation 200 utilizes an index vector Zm whose values describe positions of an output vector Zd. Further, just as example vector permutation operation 100 may be thought of as being analogous in some respects to a memory gather operation, example IDXMOV operation 200 may be thought of as analogous in some respects to a memory scatter operation (although IDXMOV operation 200 may not involve memory accesses, in implementations). Stated otherwise, example vector permutation operation 100 may involve performance of a gather of some input vector(s) of data to an output vector register, whereas example IDXMOV operation 200 involves performance of a scatter of input data to the output vector register, for example.

Example IDXMOV operation 200 is shown in FIG. 2 as comprising an input vector Zn, an output vector Zd and an index vector Zm. In implementations, input vector Zn may be stored at a first register, output vector Zd may be stored at a second register and index vector Zm may be stored at a third register. Of course, subject matter is not limited in scope to these particular details regarding hardware storage of the various data structures (e.g., vectors Zn, Zm and Zd). For the particular example depicted in FIG. 2, input vector Zn may comprise ordered values [3, 12, 5, 7, 13, 1, 9, 20] stored at a first register. Also, for the particular example depicted in FIG. 2, output vector Zd may comprise a set of ordered values [1, 3, 5, 7, 9, 12, 13, 20] stored at a second register as a result of example IDXMOV operation 200. Further, index vector Zm may comprise ordered values [1, 5, 2, 3, 6, 0, 4, 7] stored at a third register.

For example IDXMOV operation 200, the values of Zn are to be re-arranged and stored as an output vector Zd in a second register, wherein the re-arrangement is determined at least in part by the values of index vector Zm stored in a third register. For example IDXMOV operation 200, individual values of index vector Zm may specify a particular position of output vector Zd for a corresponding position of input vector Zn. That is, for example, the value “1” stored at the 0^{th} position of index vector Zm indicates that the value stored at the 0^{th} position of input vector Zn is to be stored at the 1^{st} position of output vector Zd (e.g., value “3” from the 0^{th} position of input vector Zn is stored at the 1^{st} position of output vector Zd as specified by the value at the 0^{th} position of index vector Zm). Also, for example, the value “6” stored at the 4^{th} position of index vector Zm indicates that the value stored at the 4^{th} position of input vector Zn is to be stored at the 6^{th} position of output vector Zd (e.g., value “13” from 4^{th} position of input vector Zn is stored at the 6^{th} position of output vector Zd as specified by the value at the 4^{th} position of index vector Zm), and so on. As mentioned, example IDXMOV operation 200 may be thought of as analogous in some respects to a memory scatter operation. That is, IDXMOV operation 200 may involve performance of a scatter of input data to an output vector register, for example.

As mentioned, example IDXMOV operation 200 may be directed to helping to alleviate at least some of the potential drawbacks of example vector permutation operation 100. For example, as mentioned, some vector permutation operations, such as example vector permutation operation 100, may result in increased overhead, decreased efficiency and/or decreased performance for some instruction set architectures as compared with other instruction set architectures. In some circumstances, scatter-store operations may be utilized to place input data into indexed positions, for example. However, scatter-store operations may be relatively difficult to implement efficiently, perhaps resulting in single-word micro-operations for particular processor core types. Also, for example, such scatter-store operations may fail to take advantage of locality of indices due to the considerable logic and/or other circuitry that may be required to merge micro-operations. Further, processor implementations may not dedicate integrated circuit die area for such operations. However, embodiments described herein, such as example IDXMOV operation 200, may allow software applications and/or hardware implementations to specify such “scatter” operations more efficiently in circumstances where multiple indices fall within a vector of output, for example.

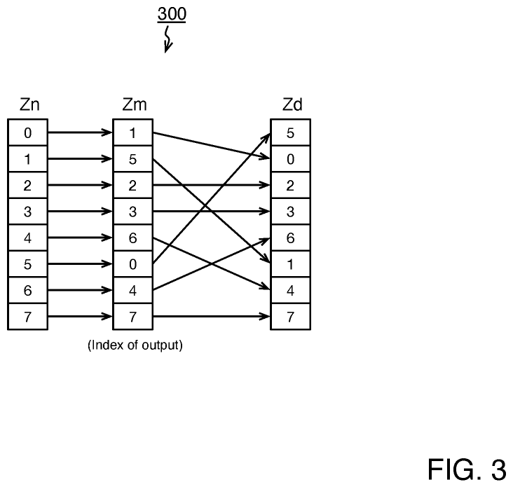

FIG. 3 is a diagram illustrating a particular example IDXMOV operation 300. Example IDXMOV operation 300 is provided in part to demonstrate that one may not efficiently utilize permute instructions that rely on input-oriented indices, such as the TBL, TBX and/or VPERM, for example, for algorithms that produce output-oriented indices. For some architectures, such as those that may be implemented in some processor core designs by ARM Limited, for example, it may be advantageous and/or necessary to first perform an IDXMOV operation 200 on an input vector Zn to generate an index vector Zm for example vector permutation operation 100. That is, for some instruction set architectures, to perform an in-register gather-type vector permutation operation, such as example vector permutation operation 100, it may first be necessary to generate an index vector Zm by performing a scatter-type operation, such as IDXMOV operation 200, on an input vector Zn, for example. Note that output vector Zd of FIG. 3 is identical to index vector Zm of FIG. 1. Thus, for at least some instruction set architectures, increased efficiency and/or performance may be achieved via implementation of an indexed vector permutation operation and/or instruction, such as example IDXMOV operation 200.

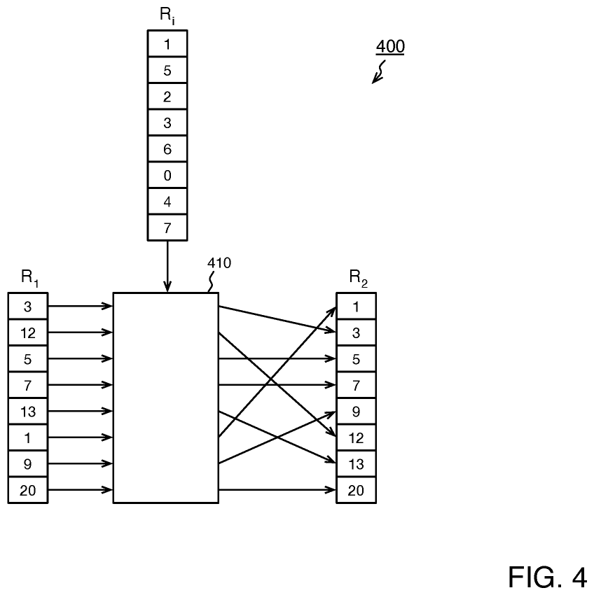

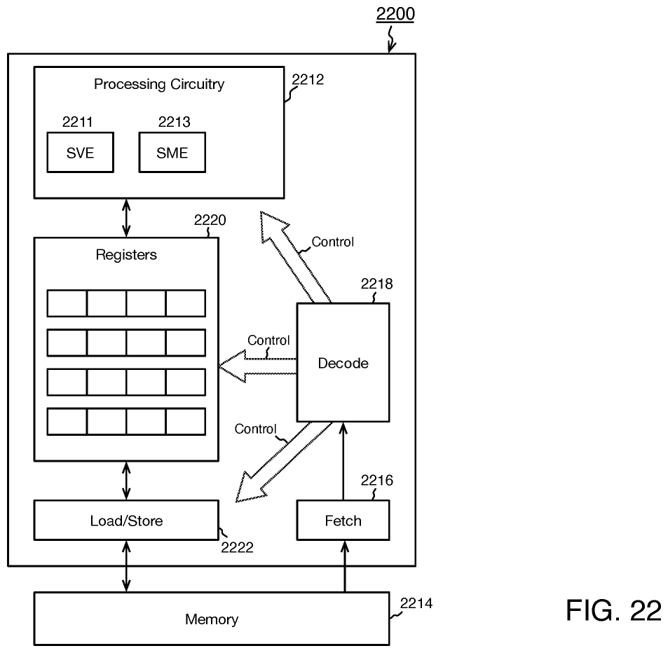

FIG. 4 is a schematic block diagram depicting an embodiment 400 of circuitry to perform an indexed vector permutation operation, such as example IDXMOV operation 200. In implementations, circuitry 400 may comprise a scalable vector execution unit (see SVE unit 2211 of FIG. 22) that may operate in accordance with an SVE instructions set architecture and/or a scalable matrix execution unit (see SME unit 2213 of FIG. 22) that may operate in accordance with an SME instruction set architecture, although subject matter is not limited in scope in these respects.

In implementations, a first register R₁ may store an input vector, such as input vector Zn, a second register R₂ may store an output vector Zd of values comprising results of IDXMOV operation 200. Also, in implementations, a third register Rᵢ may store an index vector Zm. Note that the values of vectors Zm, Zn and Zd for the example depicted in FIG. 4 are identical to the values of vectors Zm, Zn and Zd for the example depicted in FIG. 2. In implementations, registers R₁, R₂ and/or Rᵢ may comprise eight elements of sixty-four bits each. Of course, subject matter is not limited in scope in these respects. In some implementations, the indices indicated by the elements of input vector Zn and/or output vector Zd depicted in FIG. 2 and/or FIG. 4 may be associated with respective payloads, for example.

In an implementation, circuitry 410 may perform IDXMOV operation 200, for example. In some implementations, circuitry 410 may comprise a processing device (e.g., one or more processor cores). In other implementations, circuitry 410 may comprise specialized hardware (e.g., bespoke integrated circuit) designed specifically for performing IDXMOV operations. For example, circuitry 410 may comprise transistor logic circuits, encoders, decoders, multiplexors, etc. In some implementations, circuitry 410 may be clocked by a periodic signal (e.g., clock signal). Further, for example, IDXMOV operation 200, when executed by a processing device, may be generate a result within a single clock cycle, although again, subject matter is not limited in scope in these respects.

In implementations, index vector Zm may be programmable. For example, an index field of an IDXMOV instruction may allow a software application developer to specify an index vector, as described more fully below. In other implementations, an index vector may be hardcoded (e.g., fixed values expressed as part of an integrated circuit implementation) and/or may be generated at least in part via combinatorial logic and/or other circuitry of an integrated circuit device, for example.

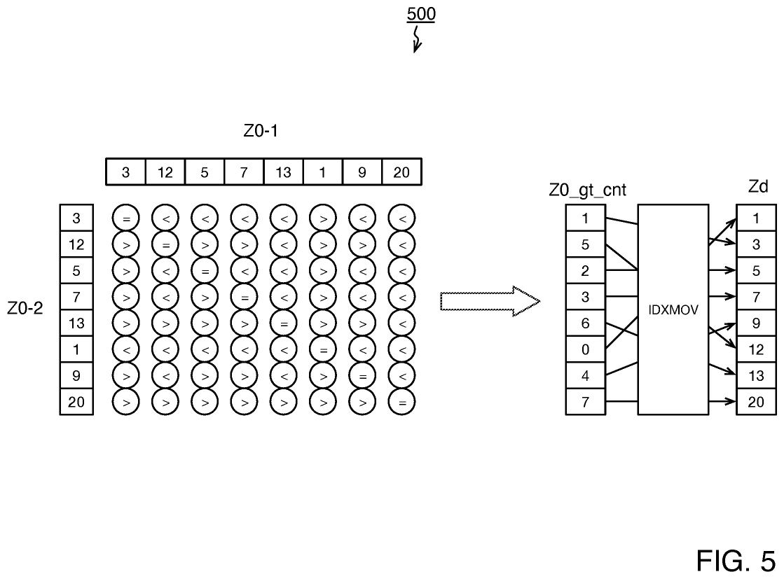

FIG. 5 is an illustration depicting an example single vector sort operation 500, including circuitry to perform an example IDXMOV operation, such as example IDXMOV operation 200, for example. For the particular example depicted in FIG. 5, single vector sort operation 500 may sort eight sixty-four bit elements in three instructions, including a two-dimensional compare instruction (CMP2D), an instruction (e.g., POPCNT, discussed below) to populate an index register with results of the two-dimensional compare instruction, and an IDXMOV instruction, such as discussed previously. For the example single vector sort operation depicted in FIG. 5, the IDXMOV operation, in accordance with embodiments and/or implementations described herein, may replace what would otherwise be eight store micro-operations. By replacing the eight store micro-operations, implementation of an IDXMOV instruction may result in increased performance and/or efficiency over circumstances where an IDXMOV instruction is not implemented.

As mentioned, example single vector sort operation 500 may include a two-dimensional compare instruction (CMP2D), an instruction (e.g., POPCNT) to populate an index register with results of the two-dimensional compare instruction, and an IDXMOV instruction. For single vector sort operation 500, an input vector Z₀ may provide both operands of the two-dimensional compare (e.g., identical input operand vectors Z0-1 and Z0-2). FIG. 5 depicts the intermediate results of individual comparisons between individual elements of a first instance of input vector Z₀ (e.g., vector Z0-1) and a second instance of input vector Z₀ (e.g., vector Z0-2). For example, the 0^{th} row of the comparison result set shows results of comparisons between the 0^{th} element of the second instance of input vector Z₀ (e.g., vector Z0-2) and individual elements of the first instance of input vector Z₀ (e.g., vector Z0-1). It may be noted that these comparisons yield a single instance wherein the 0^{th} element of vector Z0-2 is greater than the individual elements of vector Z0-1. Further, for example, the 1^{st} row of the comparison result set shows five instances wherein the 1^{st} element of vector Z0-2 is greater than the individual elements of vector Z0-1, the 2^{nd} row of the comparison result set shows two instances wherein the 2^{nd} element of vector Z0-2 is greater than the individual elements of vector Z0-1, and so forth and so on.

In implementations, single vector sort operation 500 may include an instruction (e.g., POPCNT) to populate an index register with results of the two-dimensional compare instruction, as mentioned above. For example, FIG. 5 depicts an index vector “Z0_gt_cnt” comprising values specifying a number of instances wherein a particular element of vector Z0-2 has a value that is greater than the individual elements of vector Z0-1 for a particular row of the result set. For the example depicted in FIG. 5, index vector Z0_gt_cnt may comprise values of [1, 5, 2, 3, 6, 0, 4, 7]. Of course, claimed subject matter is not limited in scope in these respects. In implementations, index vector Z0_gt_cnt may be stored in a register (e.g., index register) and/or in any other suitable storage structure.

Responsive at least in part to the population of the index register, an IDXMOV instruction may be performed wherein elements from input vector Z₀ may be scattered, in accordance with index vector Z0_gt_cnt, to an output vector Zd to produce a sorted permutation of input vector Z₀. In implementations, output vector Zd may be stored in an output register, thereby completing execution of the example single vector sort operation of FIG. 5.

As mentioned, utilizing an IDXMOV instruction in this fashion may allow for the sorting of a single vector in three instructions (e.g., a CMP2D instruction, an instruction to load comparison results into an index vector register, and an IDXMOV instruction). Without an IDXMOV instruction, it would be necessary to perform a scatter operation to contiguous locations, and then to load into a register if re-use of the sorted vector is desired. Further, for circumstances wherein a payload is associated with the indices, values, etc. of an input vector, an additional scatter-store operation (e.g., eight micro-operations) for the payload may be replaced by an IDXMOV instruction, further demonstrating the advantage of increased performance and/or efficiency that may be realized via an IDXMOV instruction.

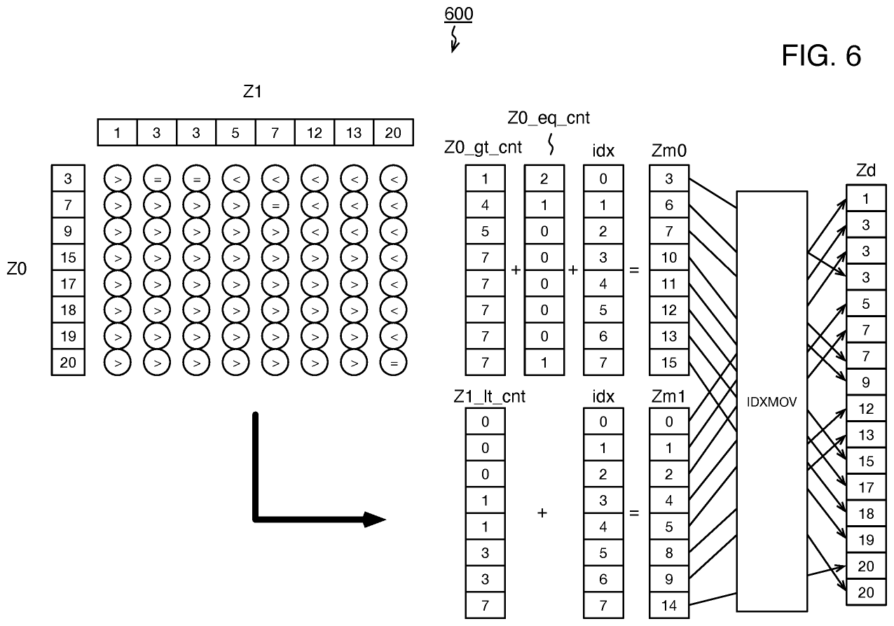

FIG. 6 is a diagram illustrating an embodiment 600 of an example merge-sort operation. For example merge-sort operation 600, a pair of input vectors Z0 and Z1 (e.g., previously individually sorted) may undergo a two-dimensional compare (CMP2D) operation, wherein individual elements of input vector Z0 are compared with individual elements of input vector Z1, thereby yielding an intermediate result set as depicted in FIG. 6. It may be noted that the comparisons between the individual elements of the two input vectors depicted in FIG. 6 may be similar in at least some respects to the comparisons discussed above in connection with FIG. 5. However, for example merge-sort operation 600, several index vectors may be generated rather than the single index vector generated as part of single vector sort operation 500. For example, index vectors indicating the number of instances of a value of input vector Z0 being greater than, equal to, and/or less than a corresponding value of input vector Z1 for individual rows of the results set may be generated.

In an implementation, an index vector indicating the number of instances of a value of input vector Z0 being greater than a corresponding value of input vector Z1 for individual rows of the results set may be labeled “Z0_gt_cnt,” an index vector indicating the number of instances of a value of input vector Z0 being equal to a corresponding value of input vector Z1 for individual rows of the results set may be labeled “Z0_eq_cnt,” and an index vector indicating the number of instances of a value of input vector Z1 being less than a corresponding value of input vector Z0 for individual rows of the results set may be labeled “Z1_It_cnt.”

In implementations, respective values from index vectors Z0_gt_cnt and Z0_eq_cnt may be added to respective values from a register IDX (e.g., values 0, 1, 2, . . . , 7) to generate values for a first index vector Zm0. Additionally, values from index vector Z1_It_cnt may be added to respective values of register IDX to generate values for a second index vector Zm1, as depicted in FIG. 6.

Also, in implementations, to continue example merge-sort operation 600, values from input vector Z0 may be sorted into output vector Zd via a pair of IDXMOV operations in accordance with the values of index vector Zm0. In implementations, output vector Zd may comprise two vectors, wherein the two vectors individually are similar in length to vectors Z0 and Z1. That is, for example, output vector Zd may have a length that is twice that of vectors Z0 and/or Z1, in some implementations. Additionally, for example, values from input vector Z1 may be sorted into output vector Zd via another pair of IDXMOV operations in accordance with the values of index vector Zm1. Output vector Zd may comprise the results of a merge-sort operation performed on input vectors Z0 and Z1. In implementations, output vector Zd may be stored in a register to enable re-use of the output vector in subsequent data processing operations, for example.

Generally, a merge-sort operation similar to merge-sort operation 600 may be implemented without the help of IDXMOV operations. For example, the four IDXMOV operations mentioned above in connection with example merge-sort operation 600 may be replaced with two scatter store operations that would result in sixteen micro-operations fora 512-bit SME instruction set architecture and/or for an SVE instruction set architecture having 64-bit keys. By replacing the scatter store operations with IDXMOV operations, the number of operations required to perform a merge-sort operation may be significantly reduced. Also, for example, a payload would also require sixteen micro-operations which would be replaced by an additional four IDXMOV operations, in implementations. Further, for 32-bit data sizes, scatter operations may double to thirty-two micro-operations each for indices (e.g., values of input vectors) and payload. In implementations, these micro-operations may be replaced by one or more IDXMOV operations (e.g., four IDXMOV operations), again increasing performance and efficiency, for example.

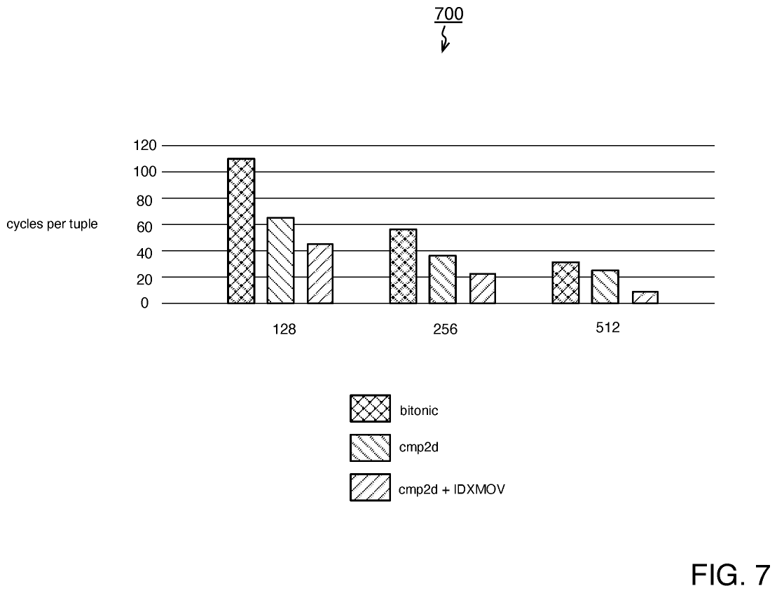

FIG. 7 is a graph 700 depicting example estimated performance measurements for a plurality of merge-sort implementations. Graph 700 depicts estimated performance for CMP2D+IDXMOV type merge-sort operations against CMP2D-type (e.g., without IDXMOV) merge-sort operations and against bitonic merge-sort operations. To achieve the estimated results of graph 700, 50,000 elements that were second-level cache (L2) resident were sorted using bitonic-type merge-sort operations, CMP2D-type merge-sort operations and CMP2D+IDXMOV type merge-sort operations.

As may be seen in graph 700 of FIG. 7, the estimated results show that CMP2D+IDXMOV merge-sort provides a relatively very large benefit over bitonic merge-sort and/or over CMP2D merge-sort. Estimated results are provided for implementations having a vector length of 128, implementations having a vector length of 256 and implementations having a vector length of 512, as shown in graph 700 of FIG. 7.

Table 1, below, shows relative speedups of CMP2D merge-sort and CMP2D+IDXMOV merge-sort over bitonic merge-sort:

TABLE 1

| Vector Length | CMP2D | CMP2D + IDXMOV |
|---|---|---|
| 128b | 1.66 | 2.3 |
| 256b | 1.48 | 2.56 |
| 512b | 1.18 | 3.08 |

For the estimated results of graph 700 and/or Table 1, the CMP2D-type merge-sort achieves a modest 1.18-1.66× speedup over bitonic merge-sort. Also, it may be noted that this speedup of CMP2D-type merge-sort over bitonic merge-sort does not appear to scale particularly effectively with vector length. This may be due at least in part to scatter micro-operations dominating runtime. This particular challenge may get worse with larger vector lengths.

For CMP2D+IDXMOV merge-sort operations, a significant speedup over bitonic merge-sort may be noted. This may be due at least in part to IDXMOV instruction allowing for in-register merge-sorting, such as discussed above in connection with FIG. 6. Additionally, the estimated results of graph 700 and/or of Table 1 also show that the CMP2D+IDXMOV merge-sort operation may scale better with vector length as compared with bitonic merge-sort. For example, for CMP2D+IDXMOV merge-sort achieved a speedup of up to 3.08× over bitonic merge-sort.

Because the indexed vector permutation operations described herein, such as indexed vector permutation operation 200 (e.g., IDXMOV), allow for in-register merge-sorting, for example, the testing routine for the results of graph 700 and/or of Table 1 included construction of four block of four vectors of sorted data elements before starting to merge blocks. At a 512 bit (16 word) vector length, this allowed for the loading of four vectors (64 tuples) of unsorted data elements and allowed for sorting them completely in-register (i.e., without accessing memory) during testing. This demonstrates an additional improvement unlocked via implementation of an IDXMOV operation such as discussed herein. Although graph 700 illustrates results for implementations of blocks of four vectors of sorted data elements before starting to merge blocks, other implementations may include blocks of eight vectors, for example. Of course, subject matter is not limited in scope in these respects.

Also, in implementations, an in-register four vector sort, such as mentioned above, may also be utilized to accelerate a clean-up phase of a quicksort operation (e.g., once the bucket size reaches four vectors). For example, an experiment was conducted wherein an odd-even cleanup (e.g., similar to bitonic operation) was replaced with a CMP2D+IDXMOV merge-sort such as discussed above and a 1.9× speedup was observed for the quicksort operation overall.

Further, in implementations, indexed vector permutation operations, such as IDXMOV operation 200, may be advantageously utilized in connection with merge-sorting for sparse matrix multiplication implementations. Experimental results show CMP2D+IDXMOV merge-sort for sparse matrix multiplication with a speedup of 1.7-3.7× over implementations without an IDXMOV instruction, for example. Based on experimental results discussed above, one might expect similar performance benefits for other multiple sorting-based problems, including, for example, sparse matrix transposition and/or polar decoding (e.g., such as in ARM Limited's 5G libraries).

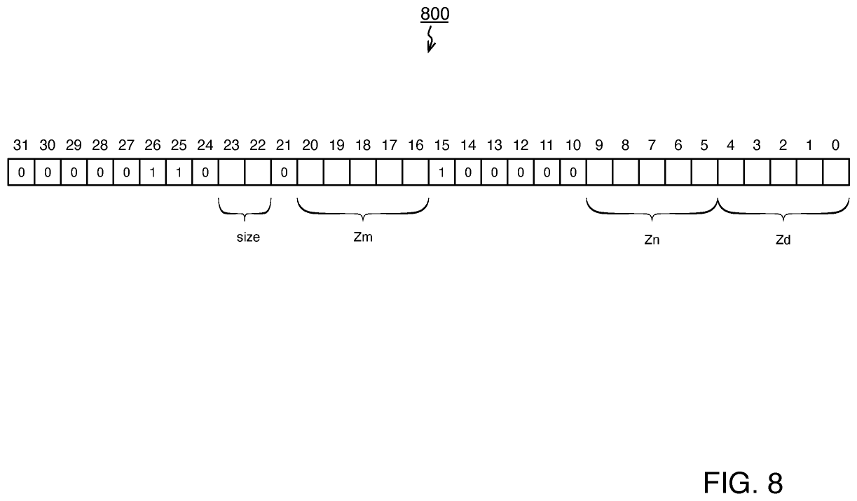

FIG. 8 is an illustration showing an example encoding/specification 800 for an indexed vector permutation (e.g., IDXMOV) instruction. In an implementation, specification 800 may comprise an example specification for an IDXMOV instruction in an SVE instruction set architecture and/or an SME instruction set architecture. In an implementation, no predicates are utilized. In implementations, data lanes that have indices outside of the specified vector length may be made implicitly inactive, for example. Of course, subject matter is not limited in scope in these respects.

For example specification 800, value 000001100b from bits 31:24 may specify an IDXMOV instruction. Further, in some implementations, bit 21 and/or bits 15:10 may further specify and/or may further characterize an IDXMOV instruction. A size field SZ at bits 23:22 may indicate any of a plurality of data elements sizes including, for example, eight bit, sixteen bit, thirty-two bit and sixty-four bit data element sizes, for example. In implementations, a two-bit size field may support up to four data element sizes. Further, in an implementation, a field “Zm” at bits 20:16 of specification 800 may store a value indicative of a particular index register (e.g., register having stored therein an index vector). Also, for example, a field “Zn” at bits 9:5 of specification 800 may store a value indicative of a particular input register (e.g., register having stored therein an input vector) and a field “Zd” at bits 4:0 may store a value indicative of a particular output register (e.g., register in which to store a result of the specified IDXMOV instruction). Of course, subject matter is not limited in scope to the particular arrangement of bits, fields, etc. of example specification 800.

As mentioned, specification 800 may specify an IDXMOV instruction. In an implementation, an IDXMOV instruction may be expressed as pseudo-code, such as the non-limiting example provided below:

IDXMOV:

```
CheckSVEEnabled( ); // ensure scalable vector extension is enabled
constant integer VL = CurrentVL; // VL = vector length
constant integer PL = VL DIV 8;
constant integer elements = VL DIV esize; // number of data elements
bits(VL) operand1 = Z[n, VL]; // specify input register
bits(VL) operand2 = Z[m, VL]; // specify index register
bits(VL) result = Z[d, VL]; // specify output register
for e = 0 to elements−1 // see FIG. 2 and related discussion herein
  integer element2 = UInt(Elem[operand2, e, esize]);
  if element2 < elements then
    Elem[result, element2, esize] = Elem[operand1, e, esize];
Z[d, VL] = result; // results stored in output register
```

As mentioned, example specification 800 of an example IDXMOV instruction may not implement predicates. That is, in implementations, a predicate register may not be needed to implement an IDXMOV operation. This may save encoding space because a predicate register may take three more bits, for example, to specify for ARM SVE. In implementations, lanes that may have their index out of range of a specified vector length may not affect the output, so a programmer may set inactive lanes of a computation by setting the indices appropriately. Note that elements with the same index can conflict. In the pseudo-code provided above, subsequent lanes may override earlier lanes of the same index, for example. In implementations, lanes that may have their index out of range may maintain a previous value within an output/destination register, such as register Zd, for example.

Although embodiments and/or implementations are described herein for indexed vector permutation operations, such as an IDXMOV operation and/or instruction, as having particular configurations, arrangements and/or characteristics, subject matter is not limited in scope in these respects. For example, although it is mentioned above that an IDXMOV instruction may be specified without predicates, other implementations may incorporate predicates. For example, predicates may be utilized within a specification of an IDXMOV operation to disable one or more data lanes at the input so that those data lanes do not affect the output. In such implementations, predicates may be utilized to mask particular data lanes, for example. Also, a single predicate may mask data lanes from two input vectors, in an implementation, because lanes of the two input vectors are mapped 1:1, for example. Again, subject matter is not limited in scope in these respects.

In other implementations, an IDXMOV operation and/or instruction and/or the like may be expanded to have two output vectors. For example, a variation of an indexed vector permutation operation (e.g., IDXMOV2) may permute into two output vectors. In such an implementation, lanes of the second output vector may correspond to indices VL (vector length) through 2*VL from the input index vector, for example.

In still other implementations, an indexed vector permutation operation, such as IDXMOV operation 200, for example, may be further expanded upon wherein an implementation may include four input vectors (e.g., two sets of keys and/or two sets of indices). For example, the four input vectors may be permuted into one or more output vectors. With four input vectors and 2 output vectors, implementations may perform four IDXMOV operations such as discussed above in connection with FIG. 6 in one instruction, for example. In implementations, this may result in four IDXMOV micro-operations in an ARM SVE implementation, partially due to the difficulty of supporting so many input and outputs in a micro-architecture. Of course, subject matter is not limited in scope in these respects.

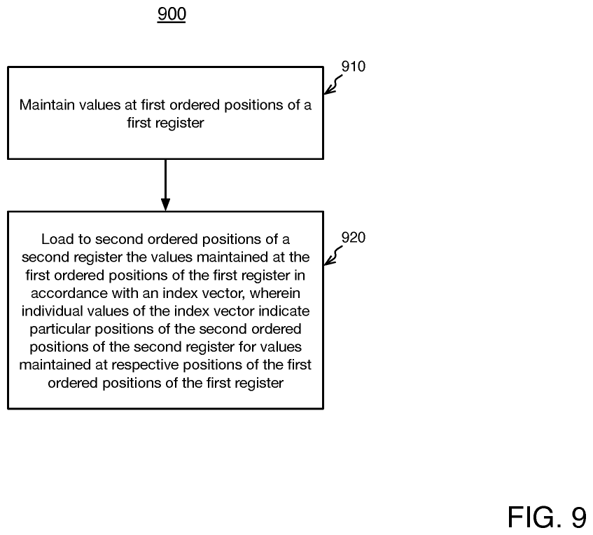

FIG. 9 is a flow diagram depicting an embodiment 900 of an example process for performing an indexed vector permutation operation (e.g., IDXMOV operation 200). In implementations, example process 900 may comprise a method of indexed vector permutation operations. In a particular implementation, process 900 may include operations that may be performed in conjunction with circuitry 400 and/or computing device 2200 (see FIG. 22), for example. It should be noted that content acquired or produced, such as, for example, input signals, output signals, operations, results, etc. associated with example process 900 may be represented via one or more digital signals and/or signal packets. It should also be appreciated that even though one or more operations are illustrated or described concurrently or with respect to a certain sequence, other sequences or concurrent operations may be employed. In addition, although the description below references particular aspects and/or features illustrated in certain other figures, one or more operations may be performed with other aspects and/or features.

In an implementation, example process 900 may include maintaining values at first ordered positions of a first register (e.g., register Zn of FIG. 2 and/or register R₁ of FIG. 4), as indicated at block 910. Also, in an implementation, example process may include loading to second ordered positions of a second register (e.g., register Zd of FIG. 2 and/or register R₂ of FIG. 4) the values maintained at the first ordered positions of the first register in accordance with an index vector (e.g., values stored in register Zm of FIG. 2 and/or register Rᵢ of FIG. 4). Further, in an implementation, individual values of the index vector may indicate particular positions of the second ordered positions of the second register for values maintained at respective positions of the first ordered positions of the first register. That is, for example, values of an index vector may indicate particular positions of a destination register to which particular values of an input vector may be written. For example, returning to the discussion related to FIG. 2, the 0^{th} element of index vector Zm comprises a value of “1.” The value of “1” at the 0^{th} position of the index vector indicates that a value stored at the 0^{th} position of input vector Zn is to be written to the 1^{st} position of a destination vector Zd, for example, as can be seen in the example depicted in FIG. 2.

In implementations, example process 900 may also include maintaining values at first ordered positions of a first register, and may also comprise loading to second ordered positions of a second register the values maintained at the first ordered positions of the first register in accordance with an index vector, wherein individual values of the index vector indicate particular positions of the second ordered positions of the second register for values maintained at respective positions of the first ordered positions of the first register. Also, for example, process 900 may further include programming a third register to store the index vector.

In implementations, loading to the second ordered positions of the second register the values maintained at the first ordered positions of the first register in accordance with the index vector may include loading to the second ordered positions of the second register the values maintained at the first ordered positions of the first register in accordance with the individual values of the index vector stored in the third register. Further, for example, a processing device may include the first register, the second register and the third register, and loading to the second ordered positions of the second register the values maintained at the first ordered positions of the first register in accordance with the index vector is performed via the processing device. Also, in implementations, loading to the second ordered positions of the second register the values maintained at the first ordered positions of the first register in accordance with the index vector may be performed within a single clock cycle of the processing device. Additionally, the loading to the second ordered positions of the second register the values maintained at the first ordered positions of the first register in accordance with the index vector within the single clock cycle may comprise an indexed move (IDXMOV) operation.

In implementations, process 900 may further comprise performing a single vector sorting operation, including: performing a two-dimensional compare operation for an input vector, storing results of the two-dimensional compare operation in the first ordered positions of the first register, and performing the IDXMOV operation, wherein values of the second ordered positions of the second register comprise results of the single vector sorting operation, wherein the single vector sorting operation is performed without storing to or gathering from random access memory. In implementations, process 900 may also include performing a two vector sorting operation, including performing a two-dimensional compare operation for a first input vector and a second input vector, storing results of the two-dimensional compare operation in the first ordered positions of the first register and in third ordered positions of a third register, and performing four IDXMOV operations, wherein values of the second ordered positions of the second register comprise results of the two vector sorting operation, wherein the two vector sorting operation is performed without storing to or gathering from random access memory.

In implementations, an IDXMOV operation may be performed at least in part in accordance with a particular specification of a particular instruction set architecture, wherein the particular specification includes a field indicating the IDXMOV operation, a field indicating a location of the first register, a field indicating a location of the second register, and a field indicating a location of the third register. In implementations, the particular specification of the particular instruction set architecture does not include a predicate field. Further, for example process 900, the individual values of the index vector are computed at least in part via particular combinatorial logic circuitry.

Above, an example CMP2D instruction and/or operation is mentioned in connection with example single vector sort operation 500 and example merge-sort operation 600. An example instruction to populate a register with comparison results is also mentioned. In implementations, a POPCNT instruction and/or operation may be utilized to count instances of a particular value within individual rows or columns of a multi-dimensional array, such as matrix tile ZA, and/or to load count results into a specified register, for example. In the discussion below, example CMP2D and POPCNT instructions and/or operations are discussed, as are example use cases for the example CMP2D, POPCNT, and/or IDXMOV instructions and/or operations.

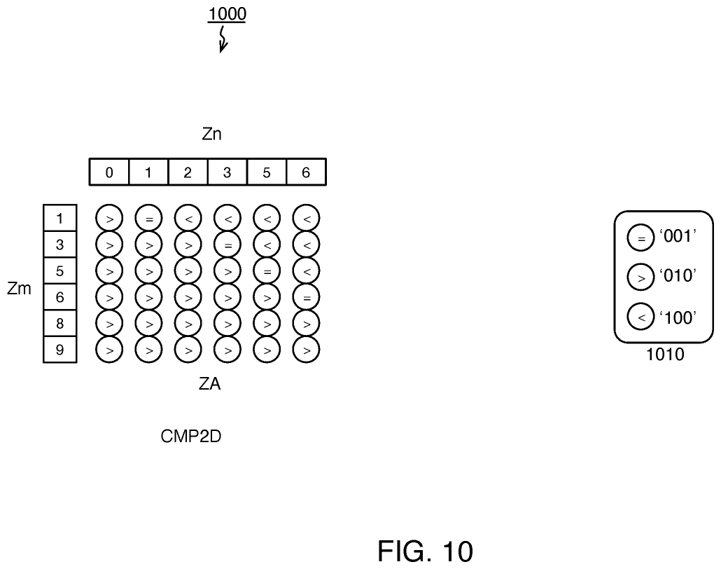

FIG. 10 is a diagram illustrating an embodiment of an example vector compare operation 1000. In implementations, example vector compare operation 1000 may comprise a two-dimensional compare (CMP2D) operation, such as mentioned above. In implementations, a CMP2D operation may comprise an all-to-all comparison of input vectors, such as vectors Zm and Zn. In implementations, vectors Zm and Zn may be stored in first and second registers, for example. To perform a CMP2D operation, each value stored at individual ordered positions of the first register may be compared with each value stored at individual ordered positions of the second register, in implementations. Further, in implementations, comparisons for a CMP2D operation may be performed, at least in part, by one or more scalable vector execution units (see SVE 2211 of FIG. 22) and/or one or more scalable matrix execution units (see SME 2213 of FIG. 22), for example.

In implementations, a scalable vector execution unit and/or a scalable matrix execution unit may comprise one or more matrix tiles, such as matrix tile ZA that may individually comprise two-dimensional arrays of comparators, arithmetic logic units (ALU), etc. that may perform comparisons related to a two-dimensional vector comparison, such as the example CMP2D operation discussed herein. Results for an all-to-all comparison may comprise a multi-dimensional (e.g., two-dimensional) array of values that may be stored in an array of storage cells of a matrix tile, such as matrix tile ZA, for example.

As mentioned, matrix tile ZA may store values representative of results of an all-to-all comparison of a CMP2D operation. In implementations, values stored at matrix tile ZA may individually comprise a plurality of bits to indicate whether an associated comparison of the all-to-all comparison results in a “less than” condition, an “equal to” condition, or a “greater than” condition. In implementations, storage cells may individually comprise three bits to indicate a less than result, an equal to result, or a greater than result for an associated comparison resulting from the all-to-all comparison, although subject matter is not limited in this respect. In an implementation, a binary value of 001 may indicate an equal to result, a binary value of 010 may indicate a greater than result, and/or a binary value of 100 may indicate a less than result, for example, as depicted at box 1010 of FIG. 10.

Although implementations discussed above are described as including various encoding schemes for values stored at a matrix tile, such as matrix tile ZA, subject matter is not limited in scope in these respects. For example, an alternative encoding scheme may utilize generalized condition codes, such as “N, Z, V, C” condition codes. In an implementation, N, Z, V, C condition codes may comprise four bits of a register (e.g., most significant bits of a 64-bit register). In implementations, a set Z flag may represent an equal to result. Further, for example, (N==Z)&(Z==0) may indicate a greater than result, and !(N==Z) may indicate a less than result.

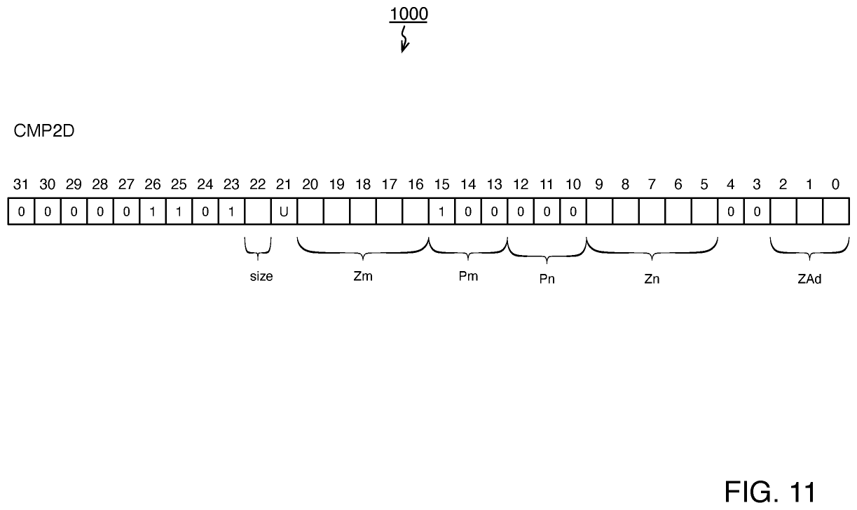

FIG. 11 is an illustration showing an example specification/encoding 1100 for example CMP2D (e.g., vector compare) instruction 1000, such as for a SVE and/or SME instruction set architecture, for example. In implementations, bits [31:23] represent an encoding specifying a CMP2D instruction. Further, for example, bit 22 may specify a data size for the CMP2D instruction. In implementations, a ‘0’ value may specify a 32bit size and/or a ‘1’ value may specify a size of 64bit. Bit 21 may specify signed or unsigned integer data values, in an implementation. Although example encoding 1100 contemplates the use of integer data, other implementations may include floating point data types.

Additionally, in implementations, bits [20:16] may specify a register for an input vector (e.g., array of values). Further, bits [9:5] may specify an additional input vector, for example. Also, for example, bits [15:13] may point to a register of predicate values pertaining to input vector Zm and bits [12:10] may point to a register of predicate values pertaining to input vector Zn, in implementations. In implementations, predicate values may specify active lanes, such as active rows and/or columns for a two-dimensional compare operation, for example.

In implementations, field ZAd at bits [2:0] may specify a particular matrix tile for the CMP2D operation. In implementations, a processing device, such as processor 2200 depicted in FIG. 22, may incorporate a plurality of matrix tiles (e.g., eight matrix tiles), wherein individual matrix tiles may comprise a two-dimensional array of circuitry to perform comparison operations and storage cells to store comparison results, for example.

As mentioned, specification 1100 may specify a CMP2D instruction. In an implementation, a CMP2D operation may be expressed as pseudo-code, such as the non-limiting example provided below:

CMP2D:

```
// input processing
CheckStreamingSVEAndZAEnabled( ); // ensure SVE and specified
    matrix tile are enabled
constant integer VL = CurrentVL; // VL = vector length
constant integer PL = VL DIV 8;
constant integer dim = VL DIV esize; // number of data elements
bits(PL) mask1 = P[a, PL]; // establish mask based on specified predicates
bits(PL) mask2 = P[b, PL];
bits(VL) operand1 = Z[n, VL]; specify input register
bits(VL) operand2 = Z[m, VL];
bits(dim*dim*esize) result;
// all-to-all comparison
for row = 0 to dim−1
  for col = 0 to dim−1
    bits(esize) sum = 0;
    if ElemP[mask1, row, esize] == ‘1’ && ElemP[mask2, col, esize] ==
    ‘1’
then
      bits(esize) element1 = Int(Elem[operand1, row, esize],
op1_unsigned);
      bits(esize) element2 = Int(Elem[operand2, col, esize],
op2_unsigned);
      if element1 == element2 then
        sum = sum + 1; // setting corresponding bit to 1, does not have
          to be addition
      if element1 > element2 then
        sum = sum + 2;
      if element1 < element2 then
        sum = sum + 4;
    Elem[result, row*dim+col, esize] = sum;
// output assignment
ZAtile[d, esize, dim*dim*esize] = result; // results stored in matrix tile
```

Although embodiments and/or implementations are described herein for two-dimensional compare instructions and/or operations, such as CMP2D, as having particular configurations, arrangements and/or characteristics, subject matter is not limited in scope in these respects.

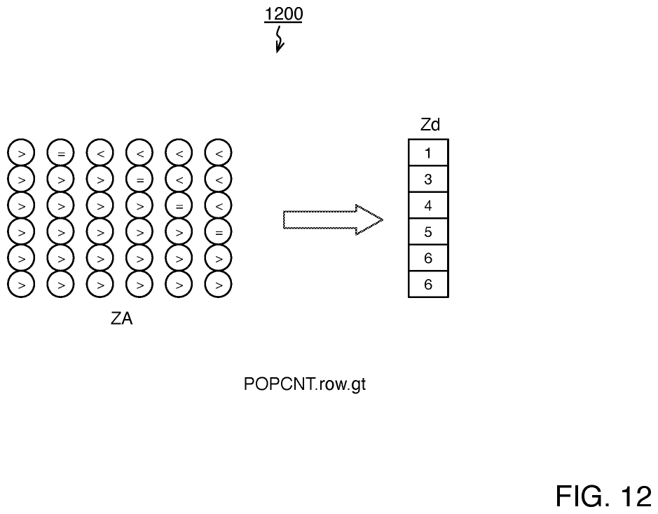

FIG. 12 is a diagram illustrating an example row/column population count operation, such as example POPCNT (population count) instruction 1200. In an implementation, POPCNT operation 1200 may reduce two-dimensional comparison results at least in part by accumulating comparison results on a row-by-row basis or on a column-by-column basis and loading count results into a destination register. For example, POPCNT operation 1200 may utilize one or more multi-way one-bit adders to accumulate instances of greater than, less than, or equal to results within individual rows or columns of a matrix tile, such as matrix tile ZA, for example.

For the example POPCNT operation depicted in FIG. 12, the number of instances of “greater than” results may be determined for individual rows of matrix tile ZA, and the determined count for the individual rows may be loaded into order positions of register Zd. As mentioned, a POPCNT operation may also be specified to accumulate “less than” results or “equal to” results. Further, a POPCNT operation and/or instruction may be specified to accumulate two-dimensional comparison results from matrix tile ZA either on a row-by-row basis or on a column-by-column basis.

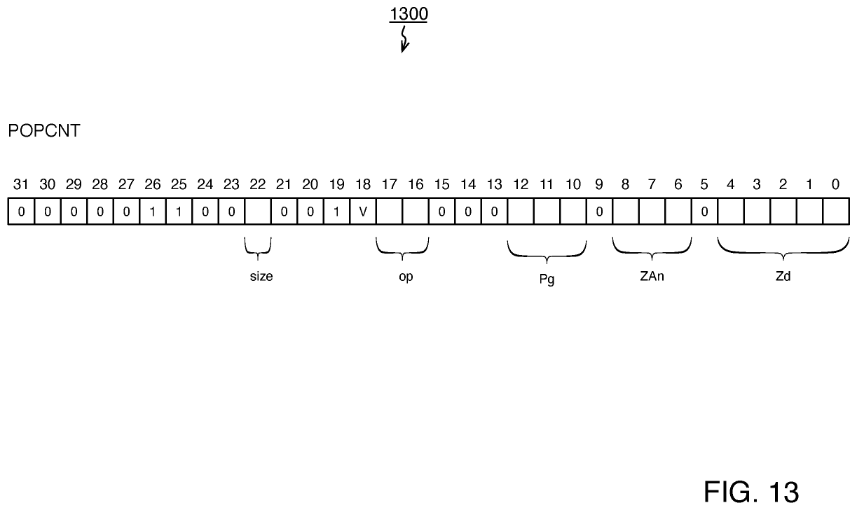

FIG. 13 is an illustration showing an example specification/encoding 1300 for example POPCNT (e.g., population count) instruction 1200, such as for a SVE and/or SME instruction set architecture, for example. In implementations, bits [31:23] represent an encoding specifying a POPCNT instruction. Further, for example, bit 22 may specify a data size for the POPCNT instruction. In implementations, a ‘0’ value may specify a 32bit size and/or a ‘1’ value may specify a size of 64bit.

In implementations, bit 18 may specify whether comparison results are to be accumulated horizontally (e.g., across individual rows) or vertically (e.g., up/down individual columns). For example, a value of ‘0’ at bit 18 may specify horizontal accumulation and a value of ‘1’ at bit 18 may specify vertical accumulation. Also, in implementations, on “op” field at bits [17:16] of example encoding 1300 may designate whether the POPCNT operation and/or instruction is to accumulate “greater than”, “less than”, or “equal to” comparison results.

In implementations, field ZAn at bits [8:6] may specify a particular matrix tile over which example POPCNT instruction 1200 is to accumulate comparison results. Also, for example, bits [12:10] may point to a register of predicate values, in implementations. In implementations, predicate values may specify active lanes, such as active rows and/or columns, for the accumulation operations of POPCNT instruction 1200.

As mentioned, example encoding 1300 may specify an example POPCNT instruction. In an implementation, a POPCNT operation may be expressed as pseudo-code, such as the non-limiting example provided below:

POPCNT:

```
// input processing
CheckStreamingSVEAndZAEnabled( );
constant integer VL = CurrentVL;
constant integer PL = VL DIV 8;
constant integer dim = VL DIV esize;
bits(PL) mask = P[g, PL];
bits(dim*dim*esize) operand = ZAtile[n, esize, dim*dim*esize];
bits(VL) result = Z[d, VL];
// comparison result accumulation
for e = 0 to dim−1
  bits(esize) sum = 0;
  if ElemP[mask, e, esize] == ‘1’ then
    bits(VL) operand = ZAslice[n, esize, vertical, e, VL];
    for i = 0 to dim−1
      integer element = UInt(Elem[operand, i, esize]);
      if element == cmask then
        // pulling the corresponding bit and then accumulate
        // do not have to be comparison
        sum = sum + 1;
  Elem[result, e, esize] = sum;
// output assignment
Z[d, VL] = result;
```

Although embodiments and/or implementations are described herein for row/column population count instructions and/or operations, such as POPCNT, as having particular configurations, arrangements and/or characteristics, subject matter is not limited in scope in these respects.

As mentioned, the example two-dimensional compare instruction and/or operation CMP2D, the example row and/or column population count instruction and/or operation POPCNT, and/or the indexed vector permutation instruction and/or operation IDXMOV may be utilized in various ways to support various example capabilities in processing devices and/or computing platforms. Several non-limiting examples are discussed below. Of course, subject matter is not limited to the specific examples discussed.

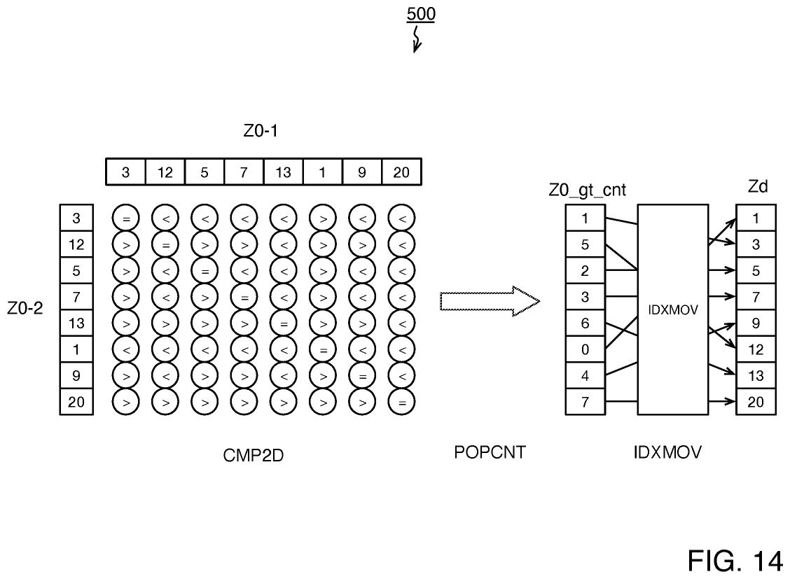

FIG. 14 is an illustration showing example single vector sort operation 500, previously discussed in connection with FIG. 5. FIG. 14 is updated here to show how the example CMP2D, POPCNT, and/or IDXMOV instructions may be utilized to implement an example single vector sort operation. For example single vector sort operation 500, example CMP2D instruction 1100, when executed via a processing device, may direct the processing device, such as processor 2200 of FIG. 22, to perform a two-dimensional compare operation, wherein input registers Z0-1 and Z0-2 are both loaded with a vector to be sorted. As discussed previously, example instruction CMP2D 1200 may result in a two-dimensional array of comparison results being stored to a matrix tile comprising a two-dimensional array of storage cells.

Additionally, to perform example single vector sort operation 500, example instruction POPCNT 1200 may direct a processing device, such as processor 2200, to accumulate comparison results on a row-by-row basis or on a column-by-column basis and may load the accumulation results for individual rows or columns to a register, such as index register Z0_gt_cnt. Example single vector sort operation 500 may also include an IDXMOV instruction that may direct a processing device, such as processor 2200, to load values from the input vector to ordered positions of a destination register, such as register Zd, based on values stored at ordered positions of index register Z0_gt_cnt. As mentioned, utilizing an IDXMOV instruction in this fashion may allow for the sorting of a single vector in three instructions (e.g., a CMP2D instruction, an instruction to load comparison results into an index vector register, and an IDXMOV instruction).

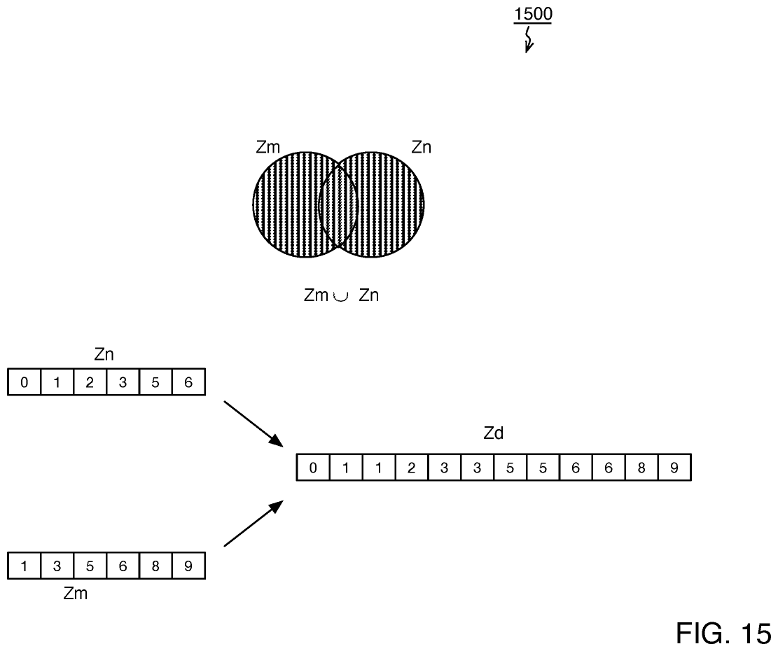

FIG. 15 depicts an illustration of an example merge-sort operation 1500, in accordance with an embodiment. Example merge-sort operation 1500 may comprise an additional example operation that may be accomplished utilizing example CMP2D, POPCNT, and/or IDXMOV instructions. For example merge-sort operation 1500, input vectors Zm and Zn may be combined in a manner to produce a sorted output vector Zd, as illustrated in FIG. 15.

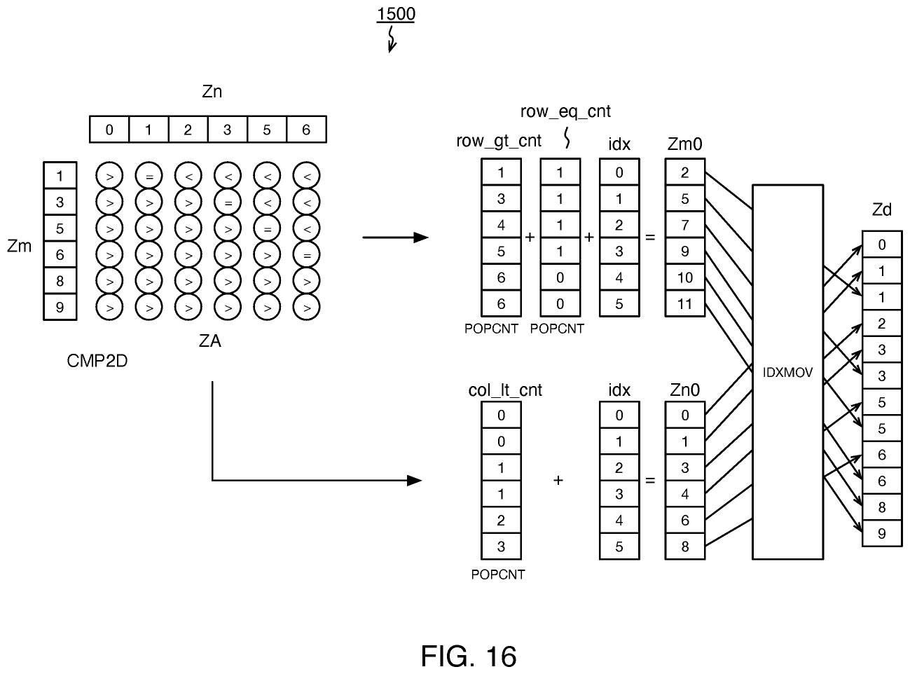

FIG. 16 is a diagram depicting additional aspects of example merge-sort operation 1500. For example merge-sort operation 1500, a pair of input vectors Zn and Zm (e.g., previously individually sorted) may undergo a two-dimensional compare operation via example CMP2D instruction 1100, wherein individual elements of input vector Zm are compared with individual elements of input vector Zm on an all-to-all basis, thereby yielding an intermediate result matrix tile ZA as depicted in FIG. 16. In an implementation, matrix tile ZA may comprise a multi-dimensional array (e.g., two-dimension array) of values stored at a plurality of storage cells. In an implementation, matrix tile ZA may comprise storage cells that are local to a processing device, such as processor 2200 (see FIG. 22).

In an implementation, a POPCNT instruction may be executed, such as via processor 2200, for example, to accumulate instances of a value indicating a “greater than” comparison result for individual rows of matrix tile ZA. In implementations, the accumulated results may be stored to ordered positions of a register, labeled here “row_gt_cnt.” Additional POPCNT instances may be executed to accumulate “equal to” values across individual rows and the accumulated results may be stored to ordered positions of a register, labeled here as “row_eq_cnt,” for example. Also, in implementations, a further POPCNT instruction may be executed, wherein instances of a “less than” comparison result may be accumulated for individual columns of matrix tile ZA, resulting in a vector stored at ordered positions of a register labeled here as “col_It_cnt.”

In implementations, example merge-sort operation 1500 may further include one or more IDXMOV operations, wherein ordered values of input vectors Zm and Zn may be loaded into ordered positions of destination vector Zd (e.g., stored at one or more registers) in accordance with vectors stored at registers Zm0 and Zn0. Values for vector Zm0 may be generated based at least in part on values of vectors row_gt_cnt, row_eq_cnt and an index vector “idx,” for example. Additionally, in implementations, values for vector Zn0 may be generated based at least in part on values of registers col_It_cnt, and index idx, as shown in FIG. 16.

In implementations, respective values from index vectors Z0_gt_cnt and Z0_eq_cnt may be added to respective values from a register IDX (e.g., values 0, 1, 2, . . . , 7) to generate values for a first index vector Zm0. Additionally, values from index vector Z1_It_cnt may be added to respective values of register IDX to generate values for a second index vector Zm1, as depicted in FIG. 6.

As discussed more fully below, duplicate values generated as a result of a merge-sort operation, such as example operation 1500, may be removed and the resulting output vector (e.g., Zd) may be compacted (e.g., values stored continuously in one or more registers), in implementations.

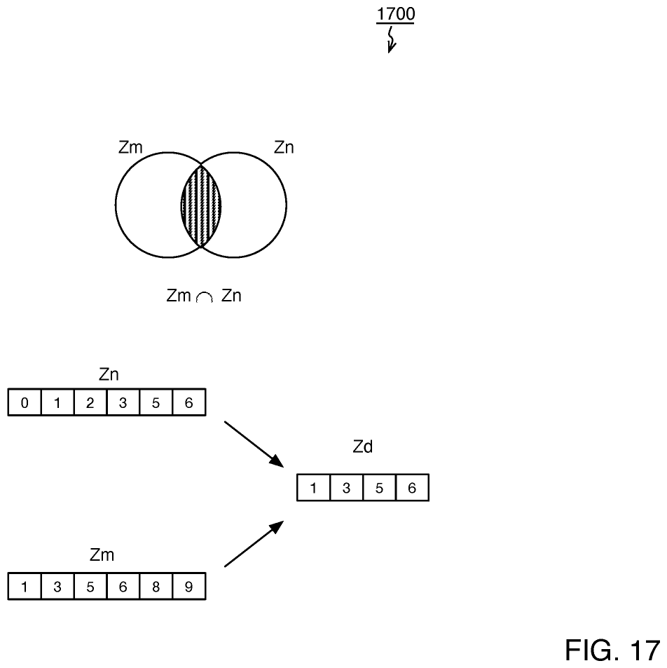

FIG. 17 depicts an illustration of an example vector intersect operation 1700, in accordance with an embodiment. Example vector intersect operation 1700 may comprise an additional example operation that may be accomplished utilizing example CMP2D and/or POPCNT instructions. As illustrated in FIG. 17, a result vector Zd may reflect an intersection of input vectors Zm and Zn. That is, result vector Zd may include values that are included in both input vectors Zm and Zn, for example. For the example of FIG. 17, the values of 1, 3, 5, and 6 of result vector Zd are present in each of input vector Zm and input vector Zn.

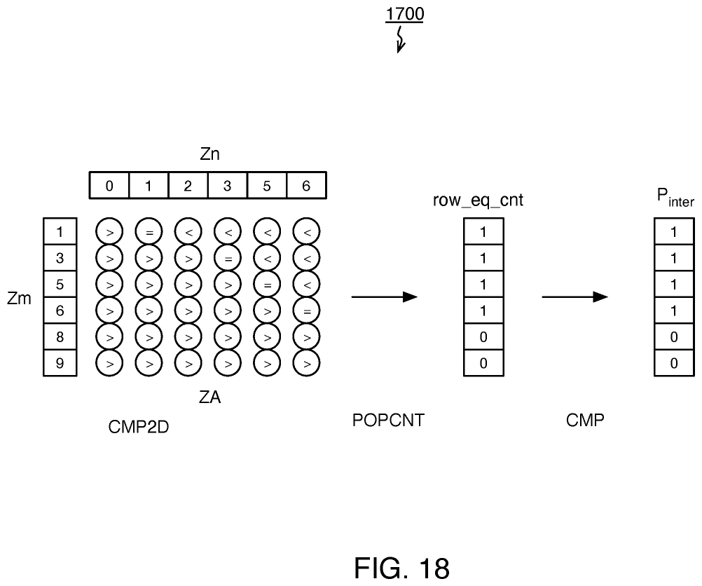

FIG. 18 is a diagram showing additional aspects of example vector intersect operation 1700, in accordance with an embodiment. In implementations, vector intersect operation 1700 may include a CMP2D instruction, wherein an all-for-all comparison may be made between input vectors Zm and Zn to produce a resulting two-dimensional array of values. See the description above for example CMP2D instruction 1000.

In implementations, example vector intersect operation 1700 may include execution of a POPCNT instruction, wherein the number of “equal to” values (e.g., 001b) may be accumulated across individual rows of comparison matrix tile ZA and wherein accumulated results may be loaded into a result register, labeled here row_eq_cnt. In implementations, values stored at ordered positions of register row_eq_cnt indicate which values of an input vector, such as input vector Zm, are to be loaded to an output register Zd (see FIG. 17).

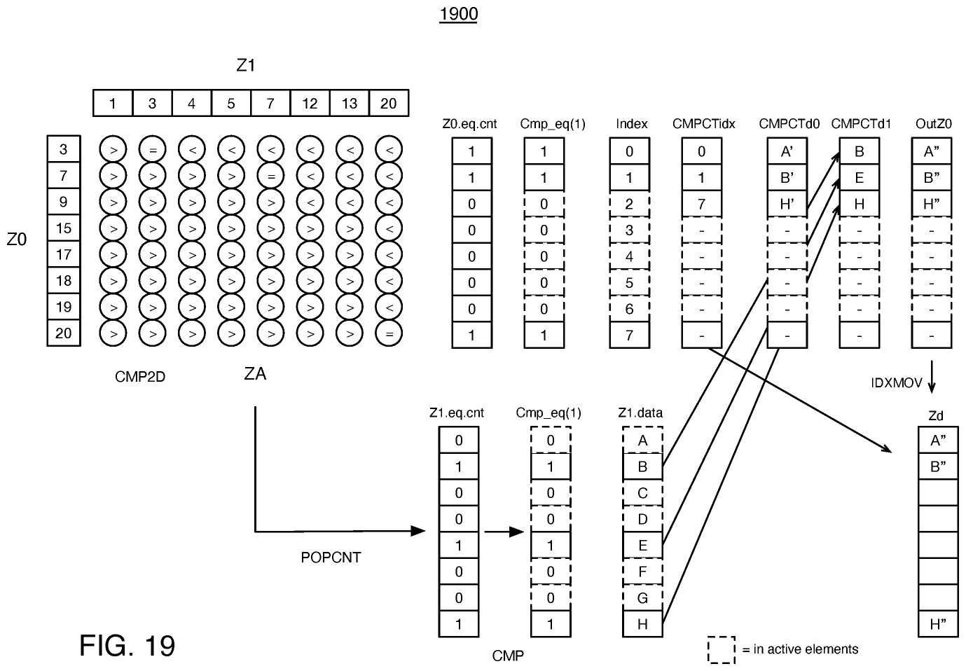

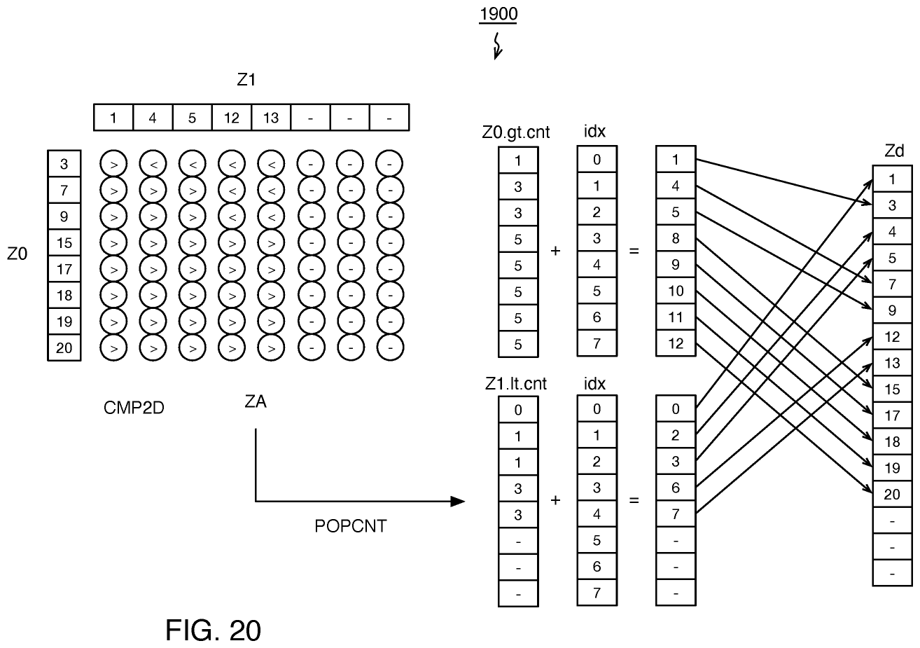

In implementations, as further illustrated at FIG. 18, a vector intersect operation, such as example vector intersect operation 1700, may be used to determine predicates for a subsequent merge-sort operation, such as merge-sort operation 1500. For example, a vector intersect operation, such as vector intersect operation 1700, may be performed to populate a register, such as register row_eq_cnt, with “equal to” comparison results. Values stored at register row_eq_cnt may be compacted such that all values indicating other than an equal to result (e.g., value of ‘0’) may be stored at continuous ordered positions of a predicate register, such as register Pinter, for example. In implementations, predicate values may be utilized in a subsequent merge-sort operation, for example, to remove duplicate values, thereby producing a result vector that does not include duplicate values. For example, a value of ‘1’ at positions of the predicate register may indicate duplicate values that may be removed from the subsequent merge-sort operation. Further, for example, a value of ‘0’ at positions of the predicate register may denote unique values for use in the subsequent merge-sort operation. See, for example, FIGS. 19-20, discussed below, for an example merge-sort operation including removal of duplicates.

FIG. 19 is a diagram showing an initial stage of an example merge-sort operation 1900, without duplicates, in accordance with an embodiment. As depicted in FIG. 19, an all-to-all comparison (e.g., CMP2D instruction) may be performed on values of input registers Z0 and Z1. Results of the all-to-all comparison may be stored in matrix tile ZA, for example. In implementations, a POPCNT operation may be performed to populate a register, such as register Z1.eq.cnt, with accumulated “equal to” comparison results on a column-by-column basis. Further, for example, values of register Z1.eq.cnt may be compared with values of ‘1’ to generate values Cmp_eq(1) which may be stored in a register. In implementations, values of ‘1’ in Cmp_eq(1) may represent duplicate values for input registers Z0 and Z1. Similarly, values of ‘0’ may represent unique values for input registers Z0 and Z1. Such data may be utilized in a subsequent stage of example merge-sort operation 1900 to remove duplicate values, thereby simplifying the merge-sort operation, as demonstrated in FIG. 20, discussed more fully below.

FIG. 20 is a diagram showing a continuation of example merge-sort operation 1900, including removal of duplicates, in accordance with an embodiment. As indicated above, values of ‘1’ in Cmp_eq(1) may indicate duplicate values between input registers Z0 and Z1. In implementations, predicate values may be applied to either rows or columns of a comparison operation. For example operation 1900, predicate values in Cmp_eq(1) may indicate which columns of matrix tile ZA to ignore in an all-to-all comparison operation (e.g., CMP2D instruction). For example operation 1900, values of input register Z1 have been compacted such that all non-predicated values are stored at contiguous locations of input register Z1.

In implementations, “greater than” results for the all-to-all comparison may be accumulated across rows of matrix tile ZA and stored in register Z0.gt.cnt via a POPCNT operation. Further, “less than” results for the all-to-all comparison may be accumulated column-by-column for matrix tile ZA and stored in register Z1.It.cnt via a POPCNT operation, for example. For example operation 1900, because duplicate values have been removed from input register Z1, comparison results accumulated and populated to register Z1.It.cnt reflect the absence of the duplicate values. In implementations, values of the depicted idx registers may provide appropriate offsets into destination register Zd to complete example merge-sort operation 1900.

In implementations, payload data may be accumulated in operations, such as merge-sort operations. For example, payloads associated with duplicate values in vector Z1 may be added to the payloads for the corresponding duplicate value in vector Z0. In this manner, payload content may not be lost when removing duplicates in a merge-sort operation, for example. Of course, accumulation is merely one example technique for reducing duplicates. Other implementations may utilize other techniques, such as minimum and maximum rather than accumulation, for example, and subject matter is not limited in scope in these respects.

Accumulation of payload content for duplicates in a merge-sort operation, such as example operation 1900, is further illustrated in FIG. 19. For example, a POPCNT operation may be performed to populate register Z0.eq.cnt, with accumulated “equal to” comparison results on a row-by-row basis. Further, as previously mentioned, values of ‘1’ in Cmp_eq(1) may represent duplicate values for input registers Z0 and Z1. In implementations, contents of Z0.eq.cnt and Cmp_eq(1) may be utilized to produce an Index vector, as shown in FIG. 19. The predicated values of the Index vector may be compacted to generate a compacted index vector CMPCTidx, for example. It may be noted that vector CMPCTidx indicates values of Z0 that are duplicates of respective values of Z1. For example, the 0^{th}, 1^{st}, and 7^{th} values of Z0 are duplicates of values of Z1. As also depicted in FIG. 19, the payload content (e.g., data) associated with the duplicate values of Z0 represented by vector CMPCTd0, denoted as A′, B′, and H′. That is, values A′, B′, and H′ represent payload data corresponding to the 0^{th}, 1^{st}, and 7^{th} values of Z0. Further, values of vector CMPCTd1 represents payload content corresponding to duplicate values found in Z1. Note that CMPCTd1 is a compacted version of Z1.data.

Again, in implementations, the overall goal of payload accumulation in this context is to add payload content from duplicate values in Z1 to payload content associated with duplicate values found in Z0. To that end, payload content from CMPCTd0 may be added to payload content from CMPCTd1, resulting in vector OutZ0, for example. Further, in implementations, vector OutZ0 may undergo an IDXMOV operation utilizing CMPCTidx as an index vector to move values A″, B″, and H″ to appropriate locations in a destination register Zd. In implementations, Zd may comprise payload content associated with Z0 with values A″, B″, and H″ replacing the initial payload content associated with values of Z0 located at the 0^{th}, 1^{st} and 7^{th} ordered positions of Z0. By replacing the initial payload content with payload content of Zd, the payload content associated with duplicate values of Z1 are not lost during the subsequent merge-sort operation depicted in FIG. 20, for example.

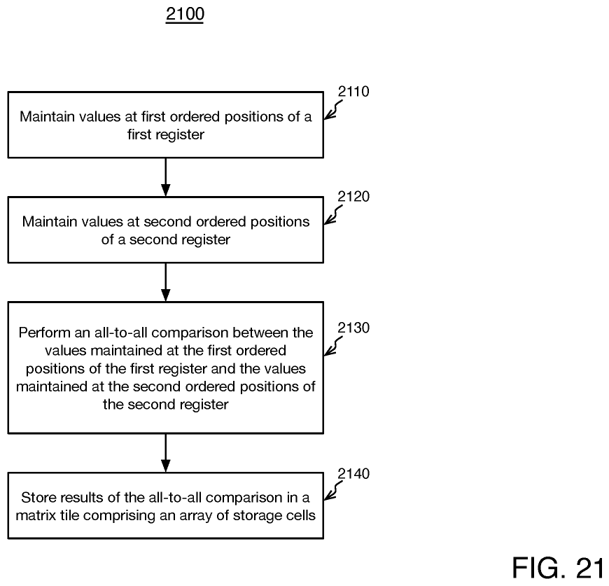

FIG. 21 is a flow diagram depicting an example process 2100 for performing a vector compare operation, in accordance with an embodiment. In implementations, process 2100 may include operations and/or instructions that may be performed in conjunction with circuitry 400 and/or processor 2200 (see FIG. 22), for example. It should be noted that content acquired or produced, such as, for example, input signals, output signals, operations, results, etc. associated with example process 2100 may be represented via one or more digital signals and/or signal packets. It should also be appreciated that even though one or more operations are illustrated or described concurrently or with respect to a certain sequence, other sequences or concurrent operations may be employed. In addition, although the description below references particular aspects and/or features illustrated in certain other figures, one or more operations may be performed with other aspects and/or features.

In an implementation, example process 2100 may include maintaining values at first ordered positions of a first register (e.g., register Zm of FIG. 10), as indicated at block 2110. Also, in implementations, example process 2100 may include maintaining values at second ordered positions of a second register (e.g., register Zn of FIG. 10), as indicated at block 2120.

Further, as indicated at block 2120, example process 2100 may include performing an all-to-all comparison (e.g., CMP2D operation and/or instruction) between the values maintained at the first ordered positions of the first register and the values maintained at the second ordered positions of the second register, in implementations. Also, as indicated at block 2140, results of the all-to-all comparison may be stored in a matrix tile, such as matrix tile ZA (e.g., see FIG. 10), wherein matrix tile ZA may comprise an array of storage cells (e.g., two-dimensional array).

In implementations, the array of storage cells may individually comprise a plurality of bits to indicate whether an associated comparison of the all-to-all comparison resulted in a less than condition, an equal to condition, or a greater than condition. Further, in implementations, the array of storage cells may individually comprise three bits to indicate a less than result, an equal to result, or a greater than result for associated comparisons resulting from the all-to-all comparison. Of course, other encodings for these results are possible. In some implementations, comparison results may be encoded using two bits, for example. In implementations, the least two or three significant bits of a register may be utilized to store comparison results, for example. As mentioned, in some implementations a binary value of 001 may indicate an “equal to” result, a binary value of 010 may indicate a “greater than result,” and/or a binary value of 100 may indicate a “less than” result. In other implementations, comparison results may be encoded utilizing a plurality of bits, wherein the plurality of bits comprise four bits N, Z, C, and V, wherein bit Z represents an equal to result, (N==Z)&&(Z==0) indicates a greater than result, and !(N==Z) indicates a less than result.

In implementations, a processing device, such as processor 2200 (discussed more fully below) may include an instruction decoder, a first register, and a second register. Further, performing the all-to-all comparison between the values maintained at the first ordered positions of the first register and the values maintained at the second ordered positions of the second register may be performed via the processing device in accordance with an instruction decoded by the instruction decoder. Also, for example, the processor may further comprise the matrix tile including the array of storage cells to store the results of the all-to-all comparison.

In implementations, example process 2100 may further include performing a POPCNT instruction and/or operation, for example, including maintaining values at third ordered positions of a third register of the processor, the processor further comprising a fourth register to receive values at fourth ordered positions of the fourth register. Additionally, example process 2100, to perform the POPCNT instruction and/or operation, may include counting, via the processing device, comparison results for individual rows or columns of the matrix tile and loading, via the processing device, the comparison results for the individual rows or columns of the matrix tile into respective positions of the third ordered positions of the third register, for example.

In implementations, example process 2100 may further comprise loading, via the processing device, such as processor 2200, values maintained in the first ordered positions of the first register to the fourth ordered positions of the fourth register in accordance with values of the third ordered positions of the third register, wherein individual values of the third ordered positions of the third register to indicate particular positions of the fourth ordered positions of the fourth register for values maintained at respective positions of the first ordered positions of the first register. In implementations, the values of the third ordered positions of the third register may comprise an index vector, such as for an IDXMOV operation, for example.

FIG. 22 is a schematic block diagram depicting an embodiment of an example processing device, such as example processor 2200. In an implementation, processor 2200 may comprise a data processing apparatus which may embody various examples of the present techniques. For example, processor 2200 may perform, in whole or in part, example embodiments described herein. Processor 2200 may comprise processing circuitry 2212 which may perform processing operations on signals and/or states (e.g., data items) responsive at least in part to a sequence of instructions which processing circuitry 2212 may execute.

In implementations, executable instructions may be retrieved from a memory 2214 to which processing circuitry 2212 may have access and, in a manner with which one of ordinary skill in the art will be familiar, fetch circuitry 2216 may be provided for this purpose. Furthermore, executable instructions retrieved by the fetch circuitry 2216 may be passed to instruction decode circuitry 2218, which may generate control signals configured to control various aspects of the configuration and/or operation of processing circuitry 2212, a set of registers 2220 and/or a load/store unit 2222. Generally, processing circuitry 2212 may be arranged in a pipelined fashion, yet the specifics thereof are not relevant to the present techniques. One of ordinary skill in the art will be familiar with the general configuration which FIG. 22 represents and further detailed description thereof is dispensed herewith merely for the purposes of brevity. In implementations, processing circuitry 2212 may comprise one or more scalable vector execution units, such as SVE unit 2211, that may operate in accordance with an SVE instructions set architecture and/or may comprise one or more scalable matrix execution units, such as SME unit 2213, that may operate in accordance with an SME instruction set architecture, although subject matter is not limited in scope in these respects.

In implementations, SVE unit 2211 and/or SME unit 2213 may comprise one or more matrix tiles. For example, individual matrix tiles may comprise an array of storage cells (e.g., two-dimensional array) that may store results of vector compare operations. In implementations, individual matrix tiles may further comprise an array of ALUs, comparators, multibit accumulators, and/or other circuitry that may perform, for example, vector compare operations. In implementations, SVE unit 2211 and/or SME unit 2213 may comprise eight matrix tiles, although subject matter is not limited in scope in these respects.

Registers 2220, as can be seen in FIG. 22, may individually comprise storage for multiple data elements, such that processing circuitry 2212 can apply data processing operations either to a specified data element within a specified register, or can apply data processing operations to a specified group of data elements (a “vector”) within a specified register. In particular the illustrated data processing apparatus is concerned with the performance of vectorized data processing operations, and specifically to the execution of vector instructions with respect to data elements held in the registers 2220, the execution of which is dependent on an index vector, as described herein. Data values required by processing circuitry 2212 in the execution of the instructions, and data values generated as a result of those data processing instructions, may be written to and/or read from the memory 2214 by means of load/store unit 2222. Note also that generally memory 2214 may be viewed as an example of a non-transitory computer-readable storage medium on which executable instructions for some implementations may be stored, typically as part of a predefined sequence of instructions (a “program”), which the processing circuitry then executes. The processing circuitry may however access such a program from a variety of different sources, such in RAM, in ROM, via a network interface, and so on.

As mentioned, processor 2200 may perform example operations discussed herein. For example, processing circuitry 2212 may perform CMP2D, POPCNT, and/or IDXMOV instructions and/or operations in accordance with CMP2D, POPCNT, and/or IDXMOV encodings/specifications decoded at instruction decode circuitry 2218 after having been fetched from memory 2214 via fetch circuitry 2216. Input vectors and/or index vectors for COMP2D, POPCNT, and/or IDXMOV instructions and/or operations, for example, may be stored in one or more of registers 2220. Also, for example, one or more of registers 2220 may store an output vector.

As discussed above, used alone and/or together, CMP2D instruction and/or operation 1000, POPCNT instruction and/or operation 1200, and/or IDXMOV instruction and/or operation 200 may allow for implementation of a number of advantageous capabilities for computing devices. For example, as discussed above, these example operations and/or instructions may be advantageously utilized in connection with sorting vector registers, merge-sorting multiple (e.g., two) vector registers, and/or calculating a set intersection between vectors. Of course, subject matter is not limited in scope to these particular applications.

Capabilities described herein, including sorting vector registers, merge-sorting multiple (e.g., two) vector registers, and/or calculating a set intersection between vectors utilizing, at least in part, CMP2D, POPCNT, and/or IDXMOV instructions and/or operations, may accelerate quick-sorting operations at least in part by enabling the quick-sorting of eight vectors of keys and eight vectors of payload data completely in-register (e.g., without having to access memory external to a processor). CMP2D, POPCNT, and/or IDXMOV instructions and/or operations may also accelerate widely utilized merge-sort operations by building eight vectors of key/payload and subsequently iteratively merging the keys/payload. Also, for example, CMP2D, POPCNT, and/or IDXMOV instructions and/or operations may accelerate smaller sorting operations used in 5G polar deciding, in implementations. Further, vector intersect capabilities, such as discussed above, may be used advantageously for triangle counting in graph mining applications, to name another non-limiting example.

FIG. 7, discussed above, depicts example simulated performance improvements for implementations incorporating CMP2D and/or IDXMOV instructions and/or operations. Additional simulated performance characteristics for implementations incorporating CMP2D, POPCNT, and/or IDXMOV instructions and/or operations are discussed below.

Simulation results may be based on an implementation of an SME unit (e.g., SME 2213 of FIG. 22) of a processing device, such as processor 2200 (see FIG. 22), including latencies (e.g., transport latencies), downclocking, and/or coherence overhead that may be associated with a decoupled matrix unit, for example. Even with the mentioned latencies and/or overhead, significant advantages may be realized for quick-sort and/or merge-sort operations. Greater improvements may be anticipated for implementations wherein the mentioned latencies and/or overhead are more fully optimized and/or improved.

Simulation results for sorting various sizes of data sets for 32b key and 32b payloads are provided. Compared to a quick-sort with odd-even cleanup (quick+OET: SVE optimized baseline), a CMP2D based clean-up offers 2.35× speedup at 4 kB and 1.35× speedup at 20 MB on an entire quick-sort. The reduced speedup for larger data sizes may be due to additional iterations of quick-sort being performed before the cleanup phase for larger data sizes, wherein the CMP2D cleanup may apply only to the cleanup phase, for example. A CMP2D based algorithm for merge-sort may also provide significant advantage over streaming SVE bitonic merge-sort (merge-Bitonic: SVE optimized baseline. A CMP2D based algorithm provides 2.14× speedup at 4 kB and 2.12× speedup at 4 MB of data for merge-sorting.

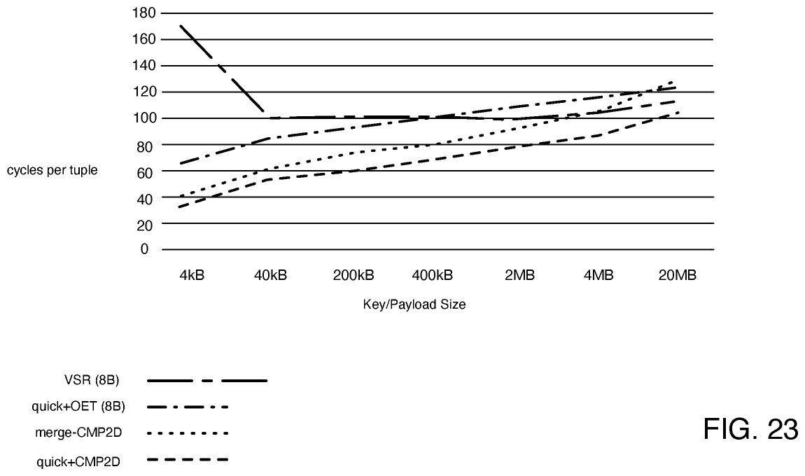

In implementations, a radix-sort algorithm may scale differently, and may thus be a better sorting algorithm for larger sorting applications. FIG. 23 depicts a graph showing simulation results for 64b data types. It may be noted that no simulation results are shown for an SVE version of bitonic merge sort for 64b data types. However, the trends depicted in FIG. 23 may be expected to be similar for 32b data types. For the depicted data types, for example, quick-sort with CMP2D cleanup offers significant advantage over quick-sort with odd-even cleanup (quick+OET). Further, quick-sort with CMP2D may retain a speedup over VSR radix sort even at 20 MB of data due at least in part to VSR not scaling as well with larger data types, for example.

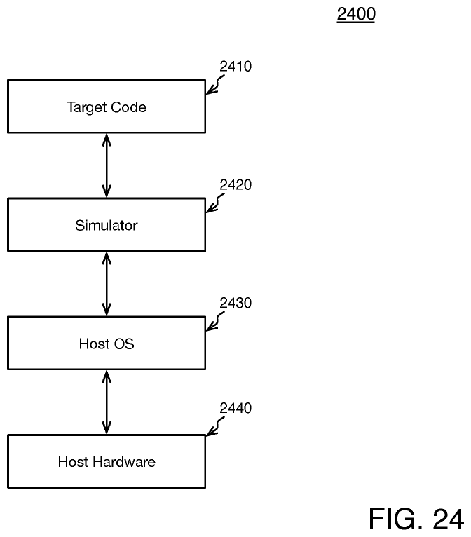

In an alternative embodiment, FIG. 24 illustrates a simulator implementation of the present technology. Whilst the earlier described embodiments implement the present technology in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software-based implementation of a hardware architecture. Varieties of simulator computer programs include emulators, virtual machines, models, and binary translators, including dynamic binary translators. Typically, a simulator implementation may run on a host hardware (e.g., host processor) 2440, optionally running a host operating system 2430, supporting the simulator program 2420. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on host hardware 2440 (e.g., host processor), some simulated embodiments may make use of the host hardware, where suitable.

The simulator program 2420 may be stored on a computer-readable storage medium (which may be a non-transitory storage medium),and provides a program interface (instruction execution environment) to target code 2110 which is the same as the application program interface of the hardware architecture being modelled by the simulator program 2420. Thus, the program instructions of the target code 2410, such as example operations 200, 500, 600, 800, 900, 1000, 1100, 1200, 1500, 1700 and/or 1900 described above, may be executed from within the instruction execution environment using the simulator program 2420, so that a host hardware 2440 which does not actually have the hardware features of the apparatus discussed above can emulate these features.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

What is claimed is:

1. A circuit, comprising:
a first register to maintain values at first ordered positions of the first register;
a second register to maintain values at second ordered positions of the second register;
circuitry to perform an all-to-all comparison between the values maintained at the first ordered positions of the first register and the values maintained at the second ordered positions of the second register; and
a matrix tile comprising an array of storage cells to store results of the all-to-all comparison.

2. The circuit of claim 1, wherein the array of storage cells to individually comprise a plurality of bits to indicate whether an associated comparison of the all-to-all comparison resulted in a less than condition, an equal to condition, or a greater than condition.

3. The circuit of claim 1, wherein the array of storage cells individually comprise three bits to indicate a less than result, an equal to result, or a greater than result for an associated comparison resulting from the all-to-all comparison.

4. The circuit of claim 1, wherein the array of storage cells individually comprise a plurality of bits, wherein the plurality of bits comprise four bits N, Z, C, and V, wherein bit Z represents an equal to result, (N==Z)&&(Z==0) indicates a greater than result, and !(N==Z) indicates a less than result.

5. The circuit of claim 1, comprising a processor including:
an instruction decoder to decode instructions, wherein the processor, including the first register and the second register and further including the circuitry to perform the all-to-all comparison between the values maintained at the first ordered positions of the first register and the values maintained at the second ordered positions of the second register, is configured to perform data processing in response to instructions decoded by the instruction decoder;
wherein the instruction decoder is configured to control, at least in part, the circuitry to perform the all-to-all comparison between the values maintained at the first ordered positions of the first register and the values maintained at the second ordered positions of the second register.

6. The circuit of claim 5, wherein the processor further comprises the matrix tile comprising the array of storage cells to store the results of the all-to-all comparison.

7. A method, comprising:
maintaining values at first ordered positions of a first register;
maintaining values at second ordered positions of a second register;
performing an all-to-all comparison between the values maintained at the first ordered positions of the first register and the values maintained at the second ordered positions of the second register; and
storing results of the all-to-all comparison in a matrix tile comprising an array of storage cells.

8. The method of claim 7, wherein the array of storage cells individually comprise a plurality of bits to indicate whether an associated comparison of the all-to-all comparison resulted in a less than condition, an equal to condition, or a greater than condition.

9. The method of claim 7, wherein the array of storage cells individually comprise three bits to indicate a less than result, an equal to result, or a greater than result for an associated comparison resulting from the all-to-all comparison.

10. The method of claim 7, wherein the array of storage cells individually comprise a plurality of bits, wherein the plurality of bits comprise four bits N, Z, C, and V, wherein bit Z represents an equal to result, (N==Z)&&(Z==0) indicates a greater than result, and !(N==Z) indicates a less than result.

11. The method of claim 7, wherein a processing device includes an instruction decoder, the first register, and the second register, wherein the performing the all-to-all comparison between the values maintained at the first ordered positions of the first register and the values maintained at the second ordered positions of the second register is performed via the processing device in accordance with an instruction decoded by the instruction decoder.

12. The method of claim 11, wherein the processing device further comprises the matrix tile comprising the array of storage cells to store the results of the all-to-all comparison.

13. An article, comprising: a non-transitory computer readable medium having stored thereon instructions executable by a processing device to provide an instruction execution environment and to:
maintain values at first ordered positions of a first register;
maintain values at second ordered positions of a second register;
perform an all-to-all comparison between the values maintained at the first ordered positions of the first register and the values maintained at the second ordered positions of the second register; and
store results of the all-to-all comparison in a matrix tile comprising an array of storage cells.

14. The article of claim 13, wherein the array of storage cells to individually comprise a plurality of bits to indicate whether an associated comparison of the all-to-all comparison resulted in a less than condition, an equal to condition, or a greater than condition, wherein the processing device further to perform a merge operation, a merge-sort operation, and/or an intersect operation based at least in part on the results of the all-to-all comparison.

15. A circuit, comprising:
a matrix tile comprising an array of storage cells to store results of an all-to-all comparison between values maintained at first ordered positions of a first register and values maintained at second ordered positions of a second register;
circuitry to accumulate comparison results for individual rows or columns of the matrix tile; and
circuitry to load the accumulated comparison results for the individual rows or columns of the matrix tile into respective positions of third ordered positions of a third register.

16. The circuit of claim 15, wherein the array of storage cells to individually comprise a plurality of bits to indicate whether an associated comparison of the all-to-all comparison resulted in a less than condition, an equal to condition, or a greater than condition.

17. The circuit of claim 15, wherein the array of storage cells to individually comprise three bits to indicate a less than result, an equal to result, or a greater than result for an associated comparison resulting from the all-to-all comparison.

18. A method, comprising:
storing results of an all-to-all comparison between values maintained at first ordered positions of a first register and values maintained at second ordered positions of a second register in a matrix tile comprising an array of storage cells;
accumulating comparison results for individual rows or columns of the matrix tile; and
loading the accumulated comparison results for the individual rows or columns of the matrix tile into respective positions of third ordered positions of a third register.

19. The method of claim 18, wherein the array of storage cells individually comprise a plurality of bits to indicate whether an associated comparison of the all-to-all comparison resulted in a less than condition, an equal to condition, or a greater than condition.

20. The method of claim 18, wherein the array of storage cells individually comprise a plurality of bits, wherein the plurality of bits comprise four bits N, Z, C, and V, wherein bit Z represents an equal to result, (N==Z)&&(Z==0) indicates a greater than result, and !(N==Z) indicates a less than result.
